(19) United States
(12) Patent Application Publication
(10) Pub. No.: US 2008/0208509 A1
(43) Pub. Date: Aug. 28, 2008

(54) System and method for graphically plotting and displaying analyte concentration data on a calendar

(75) Inventors: Julianne M. Guarino, Edwardsburg, MI (US); David R. Guarino, Edwardsburg, MI (US); Joseph E. Ruggiero, Goshen, IN (US)

Correspondence Address: NIXON PEABODY LLP, 161 N. CLARK STREET, 48TH FLOOR, CHICAGO, IL, 60601, US

(73) Assignee: Bayer HealthCare, LLC

(21) Appl. No.: 12/072,168

(22) Filed: Feb. 25, 2008

Related U.S. Application Data
(60) Provisional application No. 60/903,661, filed on Feb. 27, 2007.

(51) Int. Cl. G06F 19/00

(52) U.S. Cl. 702/122

(57) ABSTRACT

A testing device or system is adapted to determine analyte concentrations in a fluid sample and graphically plot the analyte concentrations and display them on a calendar in an easy to read and understand format.

### CROSS REFERENCE TO RELATED APPLICATION

This application claims priority to U.S. Provisional Application No. 60/903,661 filed on Feb. 27, 2007, which is incorporated by reference in its entirety.

### FIELD OF THE INVENTION

The present invention relates generally to systems for testing analyte concentrations and methods of using the same, and more particularly, to a system adapted to graphically plot analyte concentrations on a calendar and display the results to a user in an easy to read and understand format.

### BACKGROUND OF THE INVENTION

The quantitative determination of analytes in body fluids is of great importance in the diagnoses and maintenance of certain physiological abnormalities. For example, blood glucose, hemoglobin (Hb), hemoglobin A1c (HbA1c) and other analytes should be monitored in certain individuals. In particular, determining the concentration of blood glucose, Hb and HbA1c is important to diabetic individuals who must frequently check the glucose concentration in their body fluids to regulate the glucose intake in their diets. Diabetic individuals may become very ill if their blood glucose level becomes too high—a condition known as hyperglycemia. Consequently, for some individuals, it is important to know when and how often their glucose concentration readings exceed a certain glucose concentration level.

When blood glucose levels drop too low—a condition known as hypoglycemia—a person can become nervous, shaky, and confused. That person's judgment may become impaired and that person may eventually pass out. Thus, it is also important for some individuals to know when and how often their glucose concentration readings fall below a certain glucose concentration level. To determine such variations in glucose concentrations, a person will need to monitor his or her glucose levels over the course of a day, several days, a week or even a month.

Furthermore, in some individuals, it may also be important to determine how the glucose level varies over a longer period of time, i.e., greater than a month. Hemoglobin A1c (HbA1c) concentrations are used to monitor an individuals' long term glycemic control. Monitoring HbA1c levels over a longer time period, such as a two or three month period, can assist healthcare professionals in diabetes disease management.

Diabetic individuals often test their blood glucose and HbA1c levels via a blood glucose and/or hemoglobin meter. Some current meters allow users to save the test results and view them on a display. The meters may also include features that assist users in managing their testing regimen. For example, some meters may include a logbook feature to assist users in scheduling testing times during the day when concentration readings should be taken. The logbook feature may also allow a user to input a note or comment that relates to a specific concentration reading or group of readings.

Most logbook features, however, only allow for information to be displayed to the user in a textual format. This format does not easily allow users to quickly identify high and low concentration readings; nor does it allow users to identify trends or patterns in those readings. Furthermore, such formats do not allow users to review several days or weeks of concentration readings in a manner that is easy to view and understand. Instead, a user must review and dissect “pages” of textual information to understand any trends or patterns that indicate important information relating to a user's condition.

Therefore, it is desirable to provide a system or device that overcomes the disadvantages of existing systems or devices.

### SUMMARY OF THE INVENTION

According to one embodiment of the present invention, a testing device is adapted to determine an analyte concentration in a fluid sample. The testing device comprises a display adapted to display one or more analyte concentrations to a user of the testing device, a processor coupled to the display and adapted to graphically plot the one or more analyte concentrations on a calendar on the display; and at least one user input mechanism.

According to another embodiment of the present invention, a method for displaying a plurality of analyte concentrations to a user of a testing system comprises the acts of determining the plurality of analyte concentrations from a respective plurality of fluid samples, storing the plurality of analyte concentrations in a memory of the testing device and displaying the plurality of analyte concentrations by graphically plotting the analyte concentrations and displaying the plotted analyte concentrations on a calendar.

According to a further embodiment of the present invention, a testing system is adapted to determine an analyte concentration in a fluid sample. The testing system comprises a testing device including a processor adapted to graphically plot one or more analyte concentrations on a calendar, a user input mechanism and a printing device for providing a printout of the plotted concentrations on the calendar.

The above summary of the present invention is not intended to represent each embodiment, or every aspect, of the present invention. Additional features and benefits of the present invention are apparent from the detailed description, and figures set forth below.

### BRIEF DESCRIPTION OF THE DRAWING

FIG. 1 is a front view of a device or meter according to one embodiment of the present invention.

FIG. 2 is a front view of a testing system including a meter and a personal computer according to another embodiment of the present invention.

FIG. 3 is a front view of a testing system including a meter and a hand-held computer according to yet another embodiment of the present invention.

FIG. 4 is a front view of a device or meter according to a further embodiment of the present invention.

While the invention is susceptible to various modifications and alternative forms, specific embodiments are shown by way of example in the drawing and are described in detail herein. It should be understood, however, that the invention is not intended to be limited to the particular forms disclosed. Rather, the invention is to cover all modifications, equivalents and alternatives falling within the spirit and scope of the invention.

### DESCRIPTION OF ILLUSTRATED EMBODIMENTS

The present invention is directed to a testing system or meter that is adapted to determine an analyte concentration in a body fluid sample which may be collected with a lancing device. Examples of analytes which may be collected include blood glucose, hemoglobin (Hb) and hemoglobin A1c (HbA1c). Other types of analytes and/or measurements that may be taken include electrolytes, cholesterol (LDL, HDL and ratio), folic acid, human chorionic gonadotropin (hCG), luteinizing hormone (LH), triglycerides, microalbumin, fructose (Fructosamine), lactate, bilirubin, ketones, platelets, white blood cells, blood alcohol, blood urea nitrogen (BUN), C-Peptide, creatinine (urine, serum and clearance), interstitial cystitis (IC), microalbumin/creatinine ratio (uAlb/Cre Ratio), proteinuria, prostate specific angtigen (PSA), thyroxine (T4), thyroid stimulating hormone (TSH), active form of thyroxine (Free T4), very low density lipoprotein (VLDL) and enzymes such as alanine aminotransferase (ALT), aspartate aminotransferase (AST) and lactate dehydrogenase (LDH). The analyte concentrations and/or other measurements may be taken by the user of a personal testing system or meter, by a medical professional at a physician's office, at a medical laboratory, etc. It is contemplated that other analyte concentrations or measurements in addition to those mentioned above may also be determined.

The analytes may be in, for example, a whole blood sample, a blood serum sample, a blood plasma sample, other body fluids like ISF (interstitial fluid) and urine, and non-body fluids. As used within this application, the term “concentration” refers to an analyte concentration reading, activity (e.g., enzymes and electrolytes), titers (e.g., antibodies), or any other unit used to measure the desired analyte. In addition, the readings may be displayed to the user as high/low values, positive/negative values or minimum/maximum values, as well as “YES/NO” or “TRUE/FALSE” to indicate whether a specific analyte is detected.

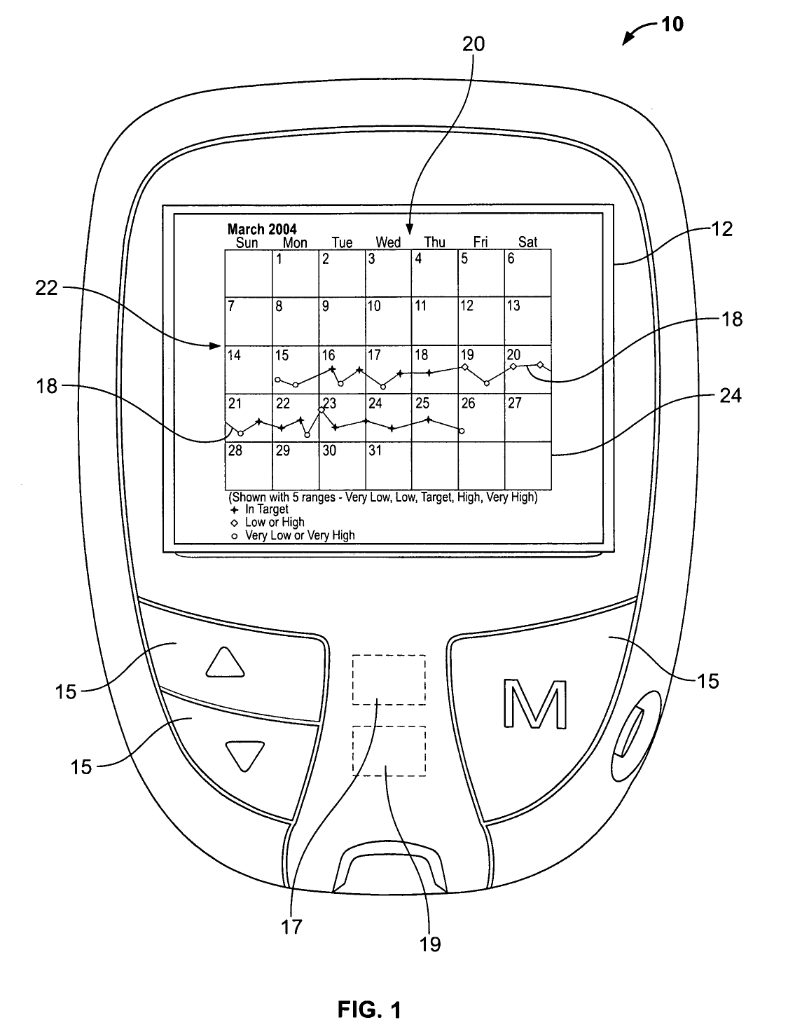

One embodiment of the present invention is a meter 10 as shown in FIG. 1. The meter 10 includes a display 12 that is adapted to display information to a user of the meter 10. The type of information that may typically be displayed to a user includes concentration readings, time and date indicators, markers, alarms, logbooks, etc., and any combination of such items. The meter 10 also has at least one user input mechanism 15 that is adapted to allow the user to make selections relating to one or more user features. The user input mechanism 15 may include, for example, buttons, scroll bars, touch screens, or any combination of such items. The meter 10 in the embodiment of FIG. 1 also includes a memory device 17 that is adapted to store concentration readings. The meter 10 may also include a processor 19 that is coupled to the display 12 and adapted to assist in displaying the concentration readings. In some embodiments, the processor 19 may also include a memory. The meter 10 may also include a software program (not shown) for providing certain user features.

The display 12 may include any of several types of displays for a graphical user interface. For example, the display 12 may include an LCD display, a graphics display, a plasma display, a backlit display, a combination segmented/graphic display or any other suitable display. In some embodiments, the meter 10 may not include a display, but instead provides a printout of the concentration readings.

The processor 19 may be adapted to assist in displaying the analyte concentrations on the display 12. The processor 19 may be coupled to the memory device 17 and may also have its own memory. The processor 19 may also be adapted to transmit information to other devices that can be used to display the concentration readings. The processor may also be adapted to receive information from other devices, such as a PDA device for example, that can be used to display the concentration readings. The software program that is included in the meter may be written in any programming language that is typically used in computers, such as Visual Basic, Java, HTML, etc., as well as spreadsheet application programs such as Microsoft Excel®.

According to one embodiment of the present invention, the meter 10 includes a feature for displaying analyte concentrations that are graphically plotted and displayed on a calendar, as shown in FIG. 1. In this embodiment, the display 12 is adapted to display concentration readings 18 plotted on a monthly calendar 20. The concentration readings 18 are plotted on the y-axis (vertical) 22 and the dates are plotted on the x-axis (horizontal) 24. As discussed in more detail below, the visual display of the concentration readings 18 on the calendar 20 makes it easier for a user to see daily, weekend, weekly and monthly concentrations and to recognize trends or patterns of concentrations that occur over a certain time frame.

In the example shown in FIG. 1, the meter 10 displays concentration readings 18 for a monthly time frame, i.e, March 2004. As shown, one or more readings 18 may be plotted for each day. In the example in FIG. 1, a total of twenty-three readings 18 are plotted over the course of twelve days. In other embodiments, more or less concentration readings 18 may be plotted and displayed to the user, covering more or less than the twelve days shown in this embodiment. In addition to plotting and displaying concentrations on a monthly basis, shorter or longer time frames may be displayed, i.e., daily, weekly, bi-monthly, etc.

To make it easier for the user to see patterns that develop over a period of time, the concentration readings 18 may be displayed in a trend format on the calendar 20. As shown in FIG. 1, the trend format displays each of the concentration readings 18 connected by a line. This type of format allows a user to more easily distinguish changes in concentrations, particularly high and low concentrations, that occur over a selected time period.

In some embodiments, the concentration readings 18 may be color-coded to indicate how individual concentration readings 18 vary with respect to a user's target range. The user's target range may be input by the user of the device, a doctor and/or healthcare professional via one or more of the input mechanisms 15. For example, in FIG. 1, a concentration reading 18 coded with a first color, i.e. green, may indicate that the analyte concentration reading 18 falls within the user's target range (“in target”). A concentration reading 18 coded with a second color, i.e., yellow, may indicate that the analyte concentration reading 18 is slightly above or slightly below the user's target range (“high” or “low”). A concentration reading 18 coded with a third color, i.e., red, may indicate that the analyte concentration reading 18 is significantly above or significantly below the user's target range (“very high” or “very low”). Such color distinctions make it easier for a user to distinguish between a user's target range and concentration readings 18 that are just above or below the target range and those that are significantly above or below the user's target range. The specific colors or numbers of colors may vary from that described above. Alternatively, different shapes, figures, designs or other indicators may be used to differentiate between the various concentration ranges, such as those ranges mentioned above or other ranges set by the user or medical professional. For example, FIGS. 1-4 display concentrations plotted on a calendar using different shapes to represent the ranges of concentrations, i.e., a “star” represents a measured concentration within the user's target range, a “circle” represents a measured concentration that is higher or lower than the user's target range and a “square” represents a measured concentration that is significantly higher or significantly lower than the user's target range.

All of the above features are designed to make it easier for a user to quickly see and understand the concentration patterns of a particular analyte over a period of time. In particular, physicians and healthcare workers are able to view monthly, weekly or day-of-the-week trends at a quick glance. The calendar 20 can also be helpful in jogging the user's memory as to certain events that occurred on a particular day to cause changes in a concentration level. Moreover, as most people (even those with little or no experience with personal computers, hand-held computers, etc.) are familiar with a calendar layout, such a display will be more user-friendly and less intimidating to people who are somewhat technophobic.

Thus, the embodiments of the present invention described above provide meters 10 that display analyte concentration readings 18 in a format that is easy to read and understand. Providing this information in a single graphical display 12 quickly allows for a determination of the amount of variability in analyte concentration readings 18 and assists the user and the healthcare professional in the treatment of the user's disease or condition. For example, after viewing the number of high and low concentration readings 18 in relation to the total number of readings conducted over a specific time frame, the user and/or the healthcare professional may be able to quickly determine if the user is achieving proper control of his or her condition. Based on the information displayed, the healthcare professional can recommend corrective actions, laboratory testing, personal regimen change, clinical therapies, etc. to address the trends that are shown by the concentrations plotted on the calendar 20.

To illustrate the use of the meter 10 and the embodiments described herein, once a blood glucose concentration reading 18 is determined, this value is saved via the memory device 17. Once one or more concentration readings 18 are determined and saved, the user (or healthcare professional) may elect to plot the concentration readings on the calendar 20. The user or healthcare professional may select, via the user input mechanisms 15, the dates that the user or healthcare professional wishes to view on the calendar 20. In one embodiment, a user or healthcare professional may select an option on the meter 10 to display a monthly calendar 20 on the display 12 with plotted concentration readings 18 as described above (and as shown in FIG. 1). The analyte concentration readings 18 are then graphically plotted and displayed on the calendar 20.

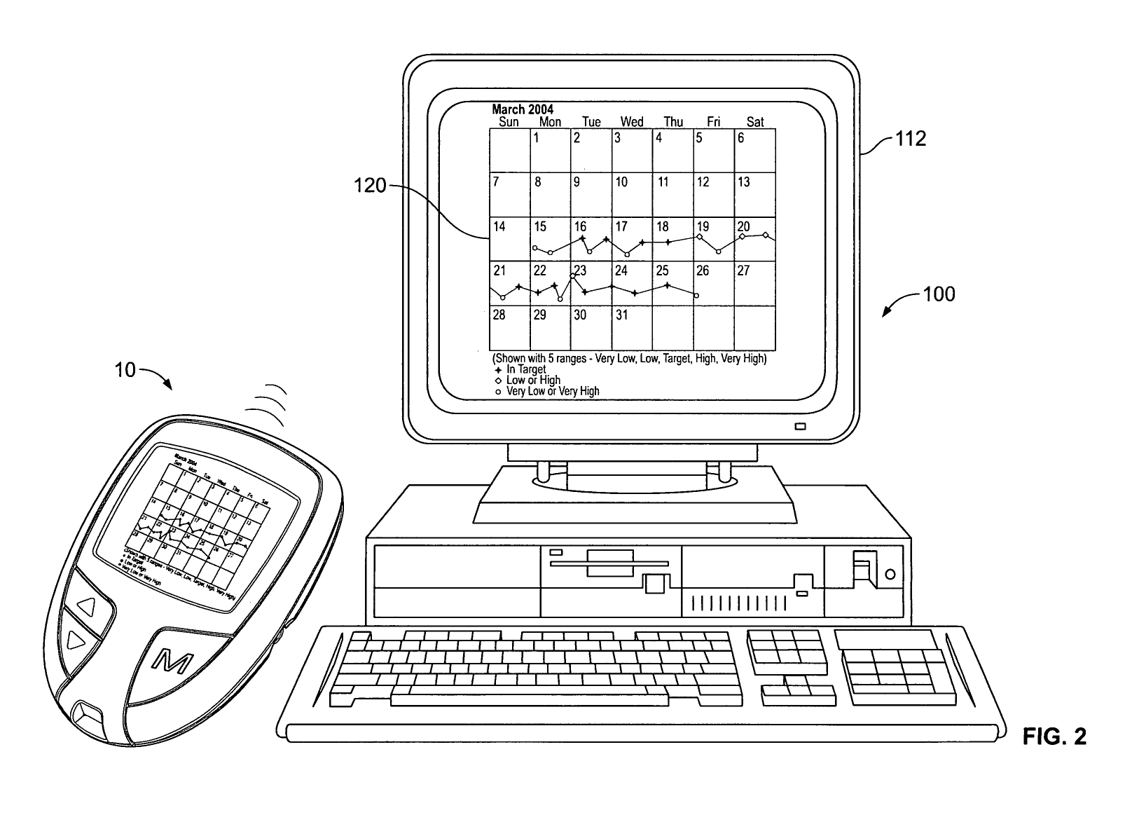

According to another embodiment, a user or healthcare professional may display the concentration readings 18 on a personal computer 100, as shown in FIG. 2. In this embodiment, the user may save the concentration readings 18 from the meter 10 onto a portable memory device (not shown), i.e., a disk, CD ROM, etc., to download onto the personal computer 100. The personal computer 100 performs the plotting of the concentrations on a calendar 120 and the user is able to view the calendar 120 on a computer monitor 112. Alternatively, the meter 10 may be connected to the personal computer 100 to download concentration data via wireless communications (as shown in FIG. 2) or via a hard-wire connection (not shown) that allows the data to be transmitted from the meter 10 to the personal computer 100, or by user entry, by scanning and importing, or by importing. In other embodiments, users may send text messages with concentration data to a physician or medical office.

The same information that may be displayed on the display 12 of the meter 10 may also be displayed on the computer monitor 112 of the personal computer 100. Alternatively, in some systems, the concentration readings are only displayed on the personal computer monitor 112 (i.e., if the meter 10 does not include a display 12). In some embodiments, once the calendar 120 is displayed on the personal computer 100, the user may select a particular data point to display the concentration reading 18 associated with that data point. The concentration reading 18 may appear in a pop-up window and may include the date and time that the reading was taken, i.e., “54 mg/dL, Jun. 10, 2004, 10:39 am.” One method of selecting a data point may be to move a mouse (not shown) connected to the computer 100 over the data point of interest. It is contemplated that other methods of selection may be used with the present invention.

In a further embodiment, the user may download the concentration data to a hand-hold computer 200, i.e., a personal digital assistant (PDA), by connecting the meter 10 to the hand-held computer via a wireless or hard-wire connection, by user entry, by scanning and importing, or by importing. In other embodiments, users may send text messages with concentration data to a physician or medical office. Similar to the meter 10 and the personal computer 100, the display 212 on the hand-held computer 200 may display a calendar 220 showing the concentrations plotted over a period of time. In some embodiments, both the display 212 on the hand-held computer 200 and the display 12 on the meter 10 may be adapted to display a calendar 20, 220, while in other embodiments, only the hand-held computer 200 displays the calendar 220 on the display 212 (i.e. if the meter 10 does not include a display 12). It is contemplated that the meter 10 and hand-held computer 200 may also provide features for selecting data points to indicate the specific time and date associated with a particular concentration reading, as described above.

In other embodiments, the testing device or meter 10 itself may not be adapted to display concentration readings plotted on a calendar. Instead, as described above, the concentration readings are transmitted to an alternative device, such as the personal computer 100 or hand-held computer 200 which plots the concentration readings and displays them on the respective display 112, 212. In other embodiments, the information may be manually entered into the personal computer 100 or hand-held computer 200 in lieu of downloading it from the meter 10.

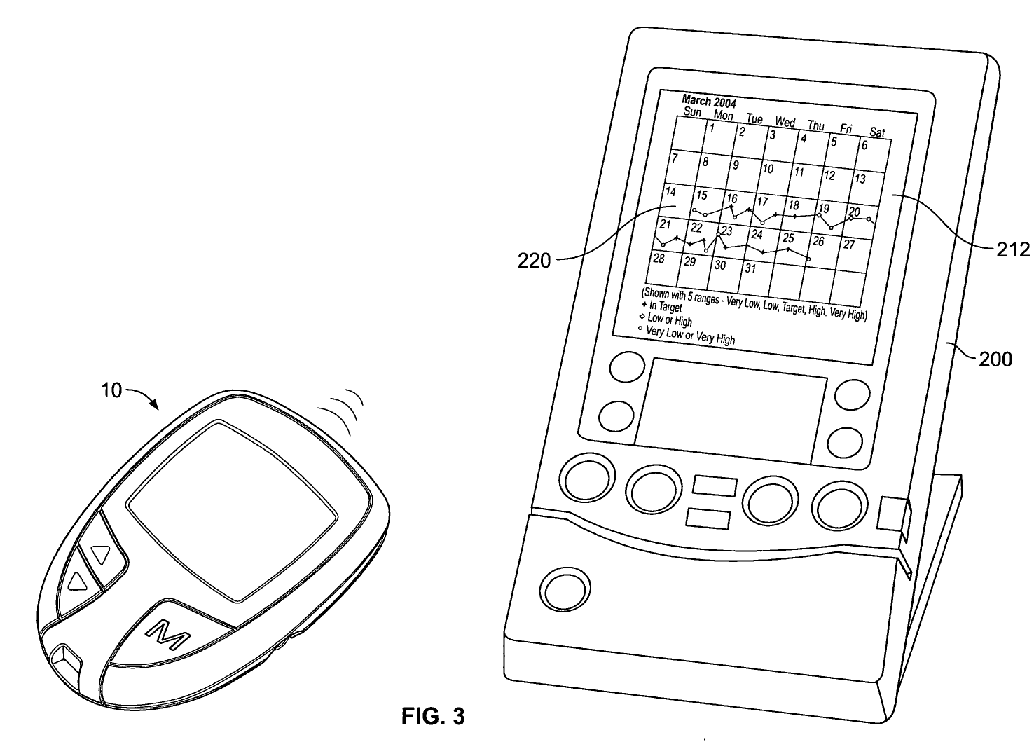

The embodiments described above with respect to FIGS. 2 and 3 may be especially useful where the person to be tested does not have his or her own meter 10. For example, for children who must have their glucose tested while in school, a personal testing device may not be available to them in that setting. In such a case, a school healthcare worker may take a glucose reading (via a testing device) and may enter the concentration reading into a system (i.e., a personal computer 100 or hand-held computer 200) that saves and plots the concentrations on a calendar for a time frame of interest. This information can then be provided to the children's parents, doctors, etc. Additionally, in hospital settings, it may be desirable to take concentration readings from one or more patients and then later enter the information into a personal computer 100 or hand-held computer 200 for plotting on a calendar and viewing by the hospital staff. The results of the testing may also be transmitted to a doctor's office, medical laboratory, etc. by fax, modem or wireless connections.

In some situations, the results of the testing may be transmitted to a laboratory information system such that a doctor or other healthcare professional may retrieve all readings for a particular patient. This enables the healthcare staff to easily and efficiently display the concentration readings in a manner that allows them to view patient-specific patterns or trends and make proper changes to a patient's course of treatment. In other embodiments, the concentration readings can be manually entered into the laboratory information system.

In yet other embodiments, it is contemplated that a kiosk located in a doctor's office may allow a user to plug the meter 10 into a receiving device, i.e., a smart printer, to provide a printout of the calendar 20 having concentration readings plotted on a daily, monthly, weekly, etc. basis. This copy may then be provided to the doctor at the time of the user's appointment.

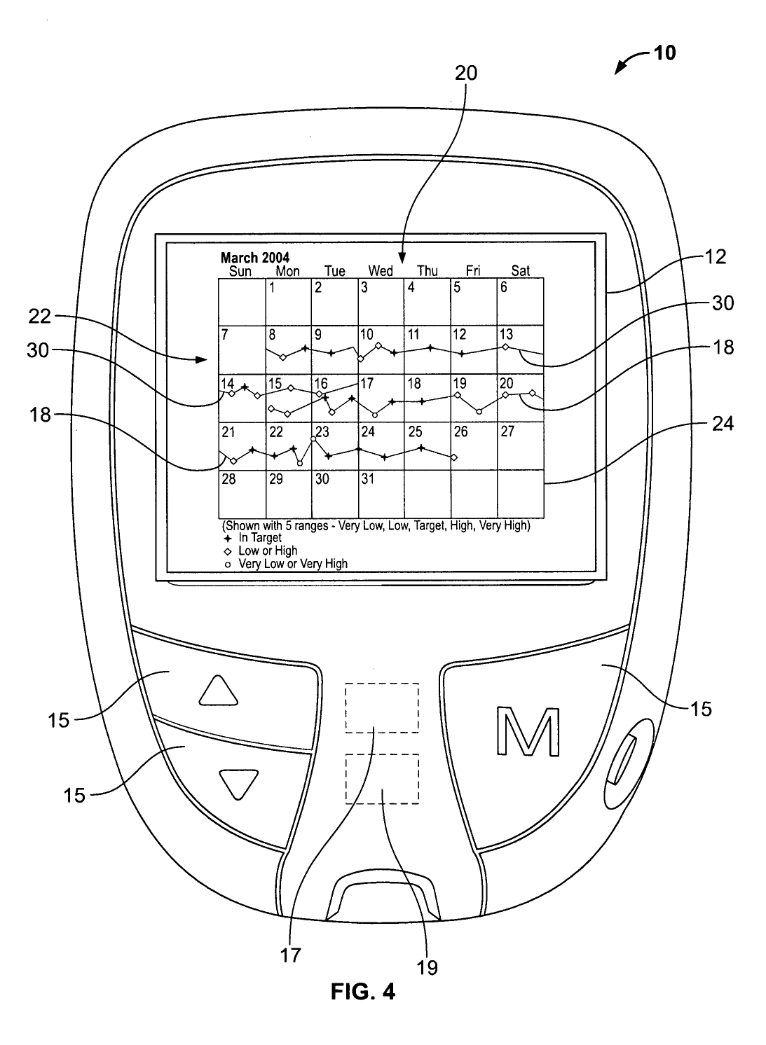

According to other embodiments, it is contemplated that more than one analyte may be displayed on the calendar 20, as shown in FIG. 4. For example, hemoglobin 10′ A1c (HbA1c) may be tested every two or three months to provide an indication of how well a person is controlling his or her glucose levels over a longer time period. In addition to displaying glucose concentration readings 18 on the calendar 20, the meter 10 (or personal computer 100 or hand-held computer 200) may also display the HbA1c readings 30 on the same calendar 20. In some embodiments, the HbA1c readings 30 may be displayed on top of or in near relation to the glucose concentration readings 18 on the calendar 20. Thus, the display 12 may include trends for two or more different analytes on the same graph using different colors, different line styles, different patterns, different shapes, etc. to differentiate between the two analytes.

The software program that is included in the meter 10 may include a method for taking and displaying the concentration readings on the calendar 20. The software program may also include a method to maneuver through or change the display (for example, via a mouse, buttons, keys, stylus, etc.) to adjust the size, position, etc. of the calendar 20. The software program may also include methods for filtering data to display selected time periods, or analytes of interest, i.e., glucose, hemoglobin, or both, and may also include methods to compare concentration readings for various time periods of interest.

Some commercially available meters, such as those that are manufactured and/or sold by Bayer Healthcare LLC of Tarrytown, N.Y., may be designed to incorporate embodiments of the present invention, such as the Ascensia® CONTOURS Blood Glucose Monitoring System, the Ascensia® BREEZE® Blood Glucose Monitoring System and the Ascensia® Elite® and Elite® XL Blood Glucose Monitoring System. It is contemplated that other meters, in addition to the ones listed above, may incorporate embodiments of the present invention as described herein.

Thus, the embodiments described herein provide a system or device that visually displays testing results in a manner that is easy for the user and/or healthcare professional to read and understand and that allows the user and/or healthcare professional to quickly see trends and/or patterns in the concentration readings to better evaluate an individual's condition and make adjustments, when necessary, to treatments and therapies. The system or device visually displays concentration readings associated with a single or multiple anlaytes in a manner that offers quick and easy tracking over a period of days, weeks or months.

While the invention is susceptible to various modifications and alternative forms, specific embodiments and methods thereof have been shown by way of example in the drawing and are described in detail herein. It should be understood, however, that the description herein is not intended to limit the invention to the particular forms or methods disclosed, but, to the contrary, the intention is to cover all modifications, equivalents and alternatives falling within the spirit and scope of the invention.

What is claimed is:

1. A testing device adapted to determine an analyte concentration in a fluid sample comprising:
a display adapted to display one or more analyte concentrations to a user of the testing device;
a processor coupled to the display and adapted to graphically plot the one or more analyte concentrations on a calendar on the display; and
at least one user input mechanism.

2. The testing device of claim 1, further comprising a memory coupled to the processor and adapted to store the analyte concentrations.

3. The testing device of claim 1, wherein the analyte concentrations are displayed on the calendar in a trend format.

4. The testing device of claim 1, wherein the analyte concentrations graphically plotted on the calendar are color-coded to indicate a user's target range.

5. The testing device of claim 4, wherein a first color indicates that the analyte concentration falls within the user's target range, a second color indicates that the analyte concentration is slightly above or slightly below the user's target range and a third color indicates that the analyte concentration is significantly above or significantly below the user's target range.

6. The testing device of claim 1, wherein the concentrations of more than one analyte are plotted and displayed on the calendar.

7. A method for displaying a plurality of analyte concentrations to a user of a testing system, the method comprising the acts of:
determining the plurality of analyte concentrations from a respective plurality of fluid samples;
storing the plurality of analyte concentrations in a memory of the testing device; and
displaying the plurality of analyte concentrations by graphically plotting the analyte concentrations and displaying the plotted analyte concentrations on a calendar.

8. The method of claim 7, wherein the plurality of analyte concentrations are plotted and displayed on a testing device.

9. The method of claim 7, further including transmitting the plurality of analyte concentrations to a personal computer or hand-held computer.

10. The method of claim 9, wherein the act of displaying the plurality of analyte concentrations by graphically plotting the analyte concentrations and displaying the plotted analyte concentrations on a calendar is performed on the personal computer or hand-held computer.

11. The method of claim 7, wherein the analyte concentration readings are plotted on the calendar in a trend format.

12. The method of claim 7, wherein the plotted analyte concentrations are color-coded to indicate a user's target range.

13. The method of claim 12, wherein a first color indicates that the plotted analyte concentration falls within the user's target range, a second color indicates that the plotted analyte concentration is slightly above or slightly below the user's target range and a third color indicates that the plotted analyte concentration is significantly above or significantly below the user's target range.

14. The method of claim 7, wherein the analyte includes blood glucose.

15. The method of claim 7, wherein the concentrations of more than one analyte are plotted and displayed on the calendar.

16. A testing system adapted to determine an analyte concentration in a fluid sample, comprising:
a testing device including a processor adapted to graphically plot one or more analyte concentrations on a calendar;
a user input mechanism; and
a printing device for providing a printout of the plotted concentrations on the calendar.
